(19) United States
(12) Patent Application Publication
(10) Pub. No.: US 2016/0095088 A1
(43) Pub. Date: Mar. 31, 2016

(54) METHODS AND SYSTEMS FOR MAINTAINING DOWNLINK OVERHEAD FOR DECODING

(71) Applicants: Shin-horng WONG, Chippenham (GB); Teck HU, Melbourne, FL (US); Min Zhang, Swindon (GB)

(72) Inventors: Shin-horng WONG, Chippenham (GB); Teck HU, Melbourne, FL (US); Min Zhang, Swindon (GB)

(21) Appl. No.: 14/497,358

(22) Filed: Sep. 26, 2014

(51) Int. Cl. H04W 72/04; H04B 1/10

(52) U.S. Cl. CPC H04W 72/042; H04B 1/10

(57) ABSTRACT

At least one example embodiment discloses a system including a network element configured to transmit a signal identifying a set of network identifiers to a victim user equipment (UE), the set including at least a first identifier and at least a second identifier, the first identifier corresponding to a descrambling of a downlink signal for the victim UE and the second identifier corresponding to a descrambling of a first interfering signal

### BACKGROUND

Network Assisted Interference Cancellation & Suppression (NAICS) provides assistance information (NA-Info) to a victim user equipment (UE) in the form of transmission parameters from an interferer cell to a victim cell for the inter-site cells and hence the NA-info consists of semi-static parameters. Parameters that are dynamic are blindly decoded by the victim UE. To help the victim UE in blind decoding, some subset restrictions on these parameters are employed at the interferer.

### SUMMARY

At least one example embodiment discloses a system including a network element configured to transmit a signal identifying a set of network identifiers to a victim user equipment (UE), the set including at least a first identifier and at least a second identifier, the first identifier corresponding to a descrambling of a downlink signal for the victim UE and the second identifier corresponding to a descrambling of a first interfering signal.

In an example embodiment, the network element is configured to identify the second identifier in one of downlink control information (DCI) and a radio resource control (RRC) signal.

In an example embodiment, the network element is configured to instruct the victim UE to use one of the network identifiers in downlink control information (DCI).

In an example embodiment, the network element is configured to instruct the victim UE to use one of the network identifiers for each time transmission interval (TTI).

In an example embodiment, the set of network identifiers is a set of scrambling identification candidates.

In an example embodiment, the set of scrambling identification candidates is for decoding the interfering signal.

In an example embodiment, a number of the network identifiers corresponds to a number of multiple user pairings.

In an example embodiment, the interfering signal occurs at a same time and frequency as the downlink signal.

In an example embodiment, the network element is configured to instruct an interfering UE to use the second identifier to descramble the interfering signal.

In an example embodiment, the network element is configured to instruct the victim UE to use the first identifier to decode the downlink signal.

In an example embodiment, the network element is configured to instruct the victim UE to use the second identifier to decode the downlink signal.

At least one example embodiment discloses a processor configured to decode an interfering signal of a downlink signal on a shared downlink channel based on a set of known network identifiers.

In an example embodiment, the processor is configured to decode the interfering signal and the downlink signal based on a known set of network identifiers including a known network identifier associated with the UE and a known network identifier associated with at least one interfering UE.

At least one example embodiment discloses a method of transmitting network identifiers in a network. The method includes obtaining a set of network identifiers for a victim user equipment (UE), the set including at least a first identifier and at least a second identifier, the first identifier corresponding to a descrambling of a downlink signal for the victim UE and the second identifier corresponding to a descrambling of a first interfering signal and transmitting the set of network identifiers to the victim UE.

In an example embodiment, the method further includes transmitting downlink control information (DCI) to the victim UE, the DCI indicating one of the network identifiers.

In an example embodiment, the method further includes instructing the victim UE to use one of the network identifiers in downlink control information (DCI).

In an example embodiment, the instructing instructs the victim UE to use one of the network identifiers for each time transmission interval (TTI).

In an example embodiment, the set of network identifiers is a set of scrambling identification candidates.

In an example embodiment, the set of scrambling identification candidates is for decoding the interfering signal.

In an example embodiment, a number of the network identifiers corresponds to a number of multiple user pairings.

In an example embodiment, the interfering signal occurs at a same time and frequency as the downlink signal.

In an example embodiment, the method further includes instructing an interfering UE to use the second identifier to descramble the interfering signal.

In an example embodiment, the method further includes instructing the victim UE to use the first identifier to decode the downlink signal.

### BRIEF DESCRIPTION OF THE DRAWINGS

Example embodiments will be more clearly understood from the following detailed description taken in conjunction with the accompanying drawings. FIGS. 1A-5 represent non-limiting, example embodiments as described herein.

FIG. 1A illustrates a wireless communication network according to an example embodiment;

FIG. 1B illustrates an example embodiment of intra-site cell interference;

FIG. 1C illustrates an example embodiment of inter-cell interference;

FIG. 2A illustrates an example embodiment of an eNB;

FIG. 2B illustrates an example embodiment of a UE;

FIG. 3 illustrates an example embodiment of UEs in a single cell of an eNB;

FIG. 4 illustrates an example embodiment of scheduled transmissions to a victim UE versus scheduled transmissions to an interfering UEs; and

FIG. 5 illustrates a method of transmitting network identifiers in a network according to an example embodiment.

### DETAILED DESCRIPTION

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. This invention may, however, be embodied in many alternate forms and should not be construed as limited to only the embodiments set forth herein.

Accordingly, while example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at, for example: existing radio access network (RAN) elements, such as eNBs; and/or existing Evolved Packet Core (EPC) network elements, such as mobile management entities (MMEs), packet data network (PDN) gateways (PGWs), serving gateways (SGWs), servers, etc. Such existing hardware may include one or more Central Processing Units (CPUs), system-on-chip (SOC) devices, digital signal processors (DSPs), application-specific-integrated-circuits, field programmable gate arrays (FPGAs) computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium”, “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

As used herein, the term “eNodeB” or “eNB” may be considered synonymous to, and may hereafter be occasionally referred to as a NodeB, base station, transceiver station, base transceiver station (BTS), etc., and describes a transceiver in communication with and providing wireless resources to users in a geographical coverage area. As discussed herein, eNBs may have all functionally associated with conventional, well-known base stations in addition to the capability and functionality to perform the methods discussed herein.

The term “user equipment” or “UE” as discussed herein, may be considered synonymous to, and may hereafter be occasionally referred to, as user, client, mobile unit, mobile station, mobile user, mobile, subscriber, user, remote station, access terminal, receiver, etc., and describes a remote user of wireless resources in a wireless communications network.

As discussed herein, uplink (or reverse link) transmissions refer to transmissions from user equipment (UE) to eNB (or network), whereas downlink (or forward link) transmissions refer to transmissions from eNB (or network) to UE.

According to example embodiments, the PGWs, SGWs, MMEs, UEs, eNBs, etc. may be (or include) hardware, firmware, hardware executing software or any combination thereof. Such hardware may include one or more Central Processing Units (CPUs), system-on-chip (SOC) devices, digital signal processors (DSPs), application-specific-integrated-circuits (ASICs), field programmable gate arrays (FPGAs) computers or the like configured as special purpose machines to perform the functions described herein as well as any other well-known functions of these elements. In at least some cases, CPUs, SOCs, DSPs, ASICs and FPGAs may generally be referred to as processing circuits, processors and/or microprocessors.

In more detail, for example, as discussed herein a MME, PGW and/or SGW may be any well-known gateway or other physical computer hardware system. The MME, PGW and/or SGW may include one or more processors, various interfaces, a computer readable medium, and (optionally) a display device. The one or more interfaces may be configured to transmit/receive (wireline or wirelessly) data signals via a data plane or interface to/from one or more other network elements (e.g., MME, PGW, SGW, eNBs, etc.); and to transmit/receive (wireline or wirelessly) controls signals via a control plane or interface to/from other network elements.

The MME, PGW and/or SGW may execute on one or more processors, various interfaces including one or more transmitters/receivers connected to one or more antennas, a computer readable medium, and (optionally) a display device. The one or more interfaces may be configured to transmit/receive (wireline and/or wirelessly) control signals via a control plane or interface.

The eNBs, as discussed herein, may also include one or more processors, various interfaces including one or more transmitters/receivers connected to one or more antennas, a computer readable medium, and (optionally) a display device. The one or more interfaces may be configured to transmit/receive (wireline and/or wirelessly) data or controls signals via respective data and control planes or interfaces to/from one or more switches, gateways, MMEs, controllers, other eNBs, UEs, etc.

As discussed herein, the PGW, SGW, and MME may be collectively referred to as Evolved Packet Core network elements or entities (or core network elements or entities). The eNB may be referred to as a radio access network (RAN) element or entity.

Serving base station may refer to the base station currently handling communication needs of the UE.

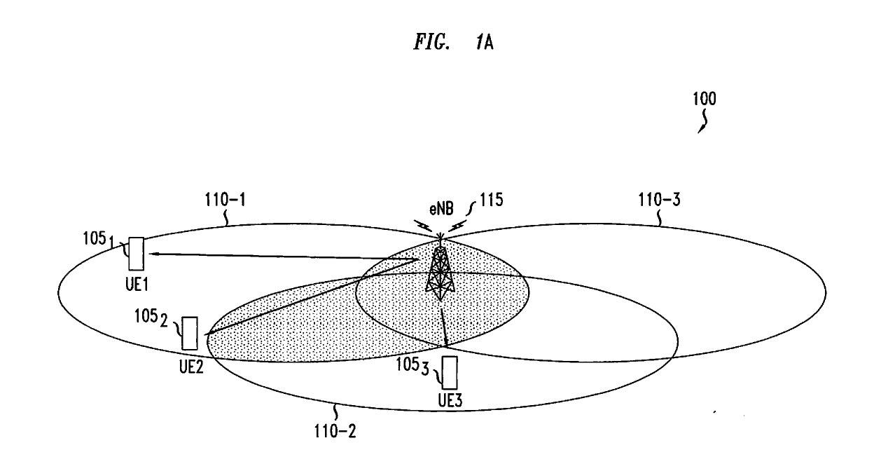

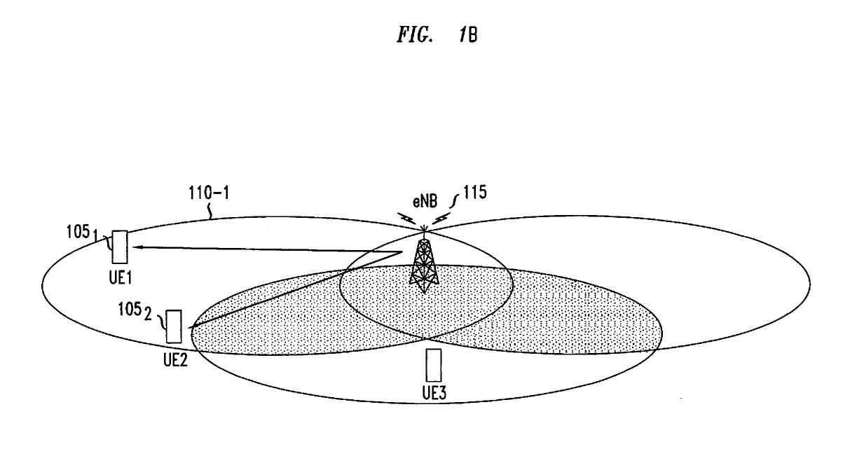

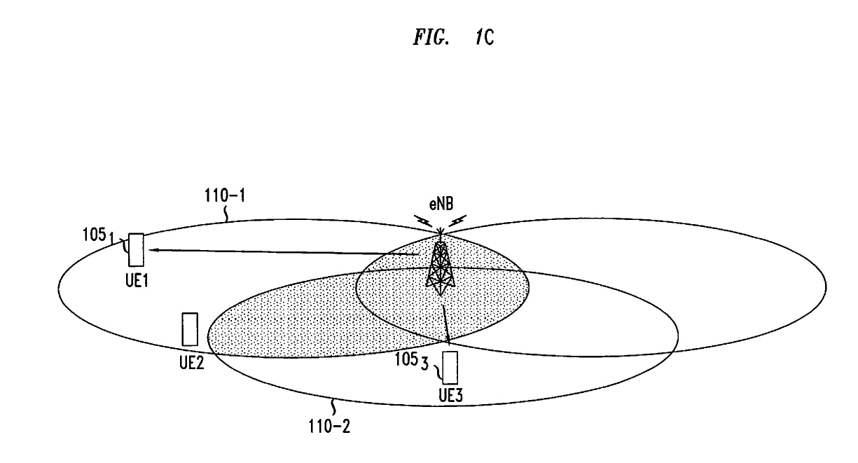

FIG. 1A illustrates a wireless communication network according to an example embodiment.

FIG. 1A illustrates a wireless communication network 100 including at least one eNodeB 115 which may communicate with an access gateway (not shown). The network may be a Long Term Evolution (LTE) network.

The access gateway is also communicatively coupled to a core network (CN) that is, in turn, communicatively coupled to one or more external networks, such as the Internet and/or other circuit and/or packet data networks. Based on this arrangement, the network 100 communicatively couples user equipments (UEs) 105₁-105N to each other and/or to other user equipments or systems accessible via external networks.

As shown, the network 100 includes the eNB 115. However, it should be understood that the network 100 may include more than one eNB 115.

The eNB 115 provides the Evolved Universal Terrestrial Radio Access (E-UTRA) user plane (PDCP/RLC/MAC/PHY) and radio resource control (RRC) plane protocol terminations with user equipments (UEs) 105.

As discussed herein, eNodeB 115 refers to a base station that provides radio access to UEs 105 within given coverage areas (e.g., 110-1, 110-2, 110-3). These coverage areas are referred to as cells. As is known, multiple cells are often associated with a single eNodeB. The eNB 115 may be considered a multiple user (MU)—multiple input multiple output (MIMO) base station and, as a result, can simultaneously provide backhaul connections to the cells 110-1, 110-2, 110-3.

In another embodiment, a single cell may be associated with a single eNB.

As discussed herein, base stations (e.g., eNodeB) may have all the functionality associated with conventional, well-known base stations in addition to the capability and functionality to perform the methods discussed herein.

Because the eNB 115 can operate MU-MIMO, the eNB 115 may communicate with the UEs 105₁-105₃ at a same time and frequency. However, the communications between the eNB 115 and the UEs 105₁-105₃ may interfere with each other. For example, a downlink signal from the eNB 115 to the UE 105₁ may be interfered by signals from the eNB 115 to the UEs 105₂ and 105₃. In such a case, the UE 105₁ is considered a victim UE and the UEs 105₂ and 105₃ are interfering UEs.

Cells can be in the same site (intra-site) or different sites (inter-site). Interference between UEs can occur in inter-site cells or intra-site cells.

As stated above, Network Assisted Interference Cancellation & Suppression (NAICS) was introduced where the network provides assistance information (NA-Info) in the form of transmission parameters from an interferer cell to a victim cell. The targeted scenario was for inter-site cells and hence the NA-info consists of semi-static parameters.

FIG. 1B illustrates an example embodiment of intra-site same cell interference. In FIG. 1B, the UE 105₁ and the UE 105₂ are in the same cell 110-1. Moreover, the UE 105₁ and the UE 105₂ are paired for MU-MIMO transmission. The interference on communications between the UE 105₁ and the eNB 115 that is caused by communications between the eNB 115 and the UE 105₂ (and vice versa) is referred to as intra-cell interference because the UEs 105₁ and 105₂ are in the same cell 110-1.

NA-info regarding the operation of the UE 105₂ can be passed to the UE 105₁ thereby allowing the UE 105₁ to cancel interference from the UE 105₂.

FIG. 1C illustrates an example embodiment of intra-site, inter-cell interference. In FIG. 1C, the UE 105₁ and the UE 105₃ are in cells 110-1 and 110-2, respectively. The UE 105₁ and the UE 105₃ are scheduled for physical downlink shared channel (PDSCH) in the same resource. The interference on communications between the UE 105₁ and the eNB 115 that is caused by communications between the eNB 115 and the UE 105₃ (and vice versa) is referred to as inter-cell interference because the UEs 105₁ and 105₃ are in different cells.

NA-info regarding transmissions of the UE 105₃ can be signaled to the UE 105₁ thereby enabling the UE 105₁ to cancel interference from the UE 105₃.

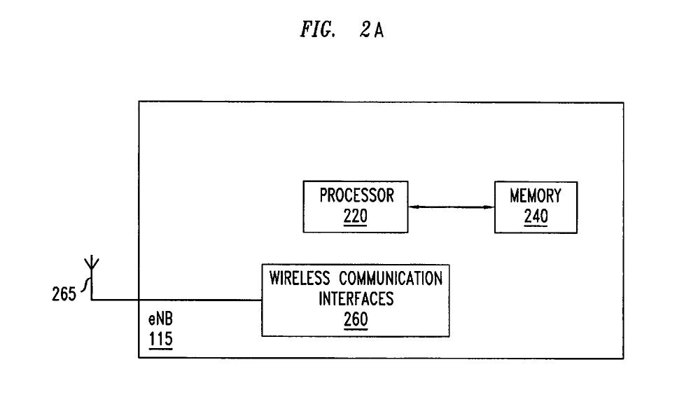

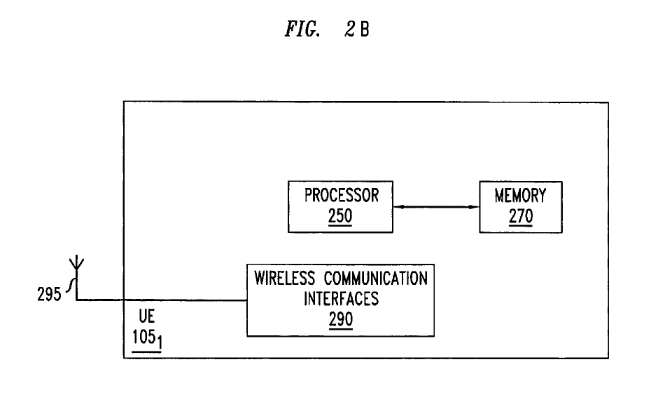

FIG. 2A illustrates an example embodiment of the eNB 115. FIG. 2 illustrates one example of the eNB 115. As shown, the eNB 115 includes a processor 220, connected to a memory 240, various interfaces 260, and an antenna 265. As will be appreciated, depending on the implementation of the eNB 115, the eNB 115 may include many more components than those shown in FIG. 2. However, it is not necessary that all of these generally conventional components be shown in order to disclose the illustrative example embodiment.

The memory 240 may be a computer readable storage medium that generally includes a random access memory (RAM), read only memory (ROM), and/or a permanent mass storage device, such as a disk drive. The memory 240 also stores operating system and any other routines/modules/applications for providing the functionalities of the eNB 115 (e.g., functionalities of a base station, methods according to the example embodiments, etc.) and to be executed by the processor 220. These software components may also be loaded from a separate computer readable storage medium into memory 240 using a drive mechanism (not shown). Such separate computer readable storage medium may include a disc, tape, DVD/CD-ROM drive, memory card, or other like computer readable storage medium (not shown). In some example embodiments, software components may be loaded into memory 240 via one of the various interfaces 260, rather than via a computer readable storage medium.

The processor 220 may be configured to carry out instructions of a computer program by performing the basic arithmetical, logical, and input/output operations of the system. Instructions may be provided to the processor 220 by the memory 240.

The various interfaces 260 may include components that interface the processor 220 with the antenna 265, or other input/output components. As will be understood, the interfaces 260 and programs stored in the memory 240 to set forth the special purpose functionalities of the eNB 115 will vary depending on the implementation of the eNB 115.

FIG. 2B illustrates one example of the UE 105₁. While only the UE 105₁ is shown, it should be understood that the UEs 105₂ and 105₃ have a similar or same structure.

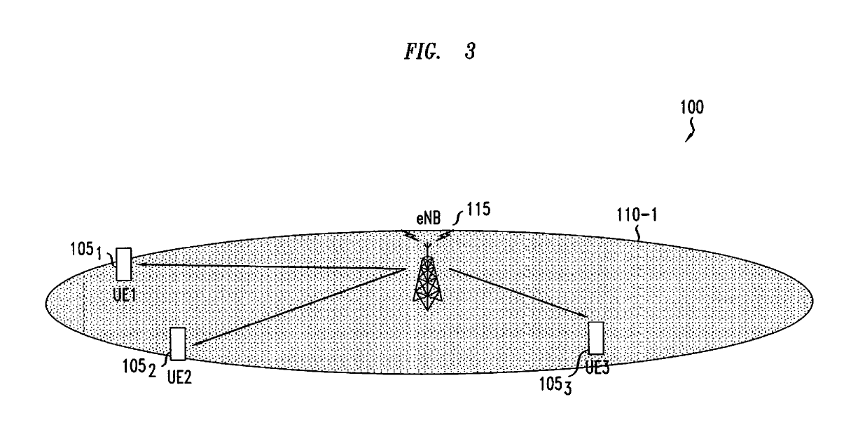

As shown, the UE 105₁ includes a processor 250, connected to a memory 270, various interfaces 290, and an antenna 295. As will be appreciated, depending on the implementation of the UE 105₁, the UE 105₁ may include many more components than those shown in FIG. 3. However, it is not necessary that all of these generally conventional components be shown in order to disclose the illustrative example embodiment.

The memory 270 may be a computer readable storage medium that generally includes a random access memory (RAM), read only memory (ROM), and/or a permanent mass storage device, such as a disk drive. The memory 270 also stores operating system and any other routines/modules/applications for providing the functionalities of the UE 105₁ (e.g., functionalities of a UE, methods according to the example embodiments, etc.) to be executed by the processor 250. These software components may also be loaded from a separate computer readable storage medium into the memory 270 using a drive mechanism (not shown). Such separate computer readable storage medium may include a disc, tape, DVD/CD-ROM drive, memory card, or other like computer readable storage medium (not shown). In some embodiments, software components may be loaded into the memory 270 via one of the various interfaces 290, rather than via a computer readable storage medium.

The processor 250 may be configured to carry out instructions of a computer program by performing the basic arithmetical, logical, and input/output operations of the system. Instructions may be provided to the processor 250 by the memory 270.

The various interfaces 290 may include components that interface the processor 250 with the antenna 295, or other input/output components. As will be understood, the interfaces 290 and programs stored in the memory 270 to set forth the special purpose functionalities of the UE 105₁ will vary depending on the implementation of the UE 105₁.

For the purposes of explanation only, the embodiments will be described with respect to the Long Term Evolution (LTE) standard. Accordingly, the well-known terminology associated with LTE will be used describing the example embodiments.

Next, operation according to example embodiments will be described.

An advantage in intra-site NAICS is that dynamic NA-info can be signaled to a victim UE compared to inter-site NAICS in 3GPP Release 12 since there is no backhaul delay in intra-site NAICS. Because the eNB 115 has knowledge of dynamic scheduling information for all victim and interfering UEs (e.g., 105₁-105₃). Unlike semi-static NA-info in Release 12, dynamic NA-info avoids blind decoding at the UE and subset restrictions at the interfering cell. More specifically, the dynamic NA-info avoids blind decoding since dynamic parameters used by the interfering UE can be dynamically signaled to the victim UE.

In other words, the reason for blind decoding is for an eNB to maintain some flexibility. For example the eNB should freely schedule a UE using QPSK, 16QAM or 64QAM. These scheduling parameters are dynamic (i.e. made on the fly for the same subframe). It is difficult to send such info in advance. To maintain such flexibility, the UE would have to blind decode (e.g. try all possible scenarios, in this case try QPSK, 16QAM and 64QAM and decide which is the right one). For some parameters, it is difficult for a UE to blind decode, an example is transmission mode (there are 10 of them) and so a compromise is made where the eNB restricts the number of transmission mode to say 6 and tells the victim UE which one it will use. In dynamic NA-info all this information can be sent to the UE dynamically and so the UE does not need to blind decode.

Furthermore, the eNB 115 may provide dynamic NA-info to the UEs 105₁-105₃ that include additional parameters such as transport block size (TBS) thereby allowing advanced receivers used in UEs 105₁-105₃ to perform interference cancellation, for example at the codeword level. However, the amount of information used to perform interference cancellation in advance receivers such as codeword level interference cancellation can be high.

In codeword interference cancellation, decoding on the interfering signal is performed by a victim UE (e.g., UE 105₁), which includes demodulation, descrambling, fragmentation, deinterleaving and derate matching, decoding and desegmentation.

For codeword interference cancellation, the descrambling of the interference is performed by the victim UE. In some methods, the victim UE requires/needs to know the UE ID for the interferer, i.e. radio network temporary identifier (RNTI) per interferer in order to perform the descrambling process.

Each RNTI consists of 16 bits. Since the RNTI is sent by the eNB 115 to the victim UE dynamically, the RNTI is sent in the DCI. Sending each RNTI of an interferer increases the DCI overhead leading to reduced robustness of the DCI message and coverage of control channel.

Accordingly, example embodiments provide methods and systems that allow the victim UE to decode an interfering UE's up to the codeword level without significantly increasing the overhead of the DCI.

More specifically, example embodiments utilize a (set of) network assisted RNTI (NA-RNTI) for a data region (PDSCH and EPDCCH).

Referring back to FIG. 1A, in an example embodiment, the eNB 115 provides the victim UE (e.g., UE 105₁) and interfering UEs (e.g., UEs 105₂ and 105₃) with a same set of NA-RNTIs using high layer signaling (e.g., RRC signaling) to allow mutual interference cancellation. This also avoids having to dynamically signal the RNTI of the interfering UE to the victim UE.

The NA-RNTI(s) may be provided to the UE by the eNB 115 when the UE is configured to operate in NAICS via RRC configuration.

The NA-RNTI(s) may be generated by the eNB 115 RNTI and can be a simple counter. For example, starting from 1000, a next UE comes in and is assigned 1001, etc. However, the generation of the NA-RNTI(s) should not be limited thereto.

For example, the eNB 115 provides a set of NA-RNTI(s) by high layer signaling to the victim UE such that the victim UE can descramble the interfering signal by searching within the set of NA-RNTIs.

Moreover, the eNB 115 provides the set of NA-RNTI(s) by high layer signaling to the interfering UE.

The eNB 115 also indicates which of the plurality of NA-RNTIs by dynamic layer signaling, such as via downlink control information (DCI), that the interfering UE should use in performing descrambling process of its own downlink signal.

FIG. 3 illustrates an example of UEs 105₁-105₃ being in the cell 110-1 of the eNB 115. FIG. 3 is used for the purposes of describing the use of the NA-RNTI.

As shown in FIG. 3, the UEs 105₁-105₃ are served by the cell 110-1. The cell 110-1 may configure the following RNTI for all three UEs 105₁-105₃ as follows:

UE 105₁—UE ID #1, NA-RNTI#1, NA-RNTI#2, NA-RNTI#3

UE 105₂—UE ID #2, NA-RNTI#1, NA-RNTI#2, NA-RNTI#3

UE 105₃—UE ID #3, NA-RNTI#1, NA-RNTI#2, NA-RNTI#3

In other words, the eNB 115 provides each UE 105₁-105₃ with a set of possible user IDs (e.g., RNTIs).

The user identifications UE ID #1, UE ID #2 and UE ID #3 are conventional C-RNTIs (e.g., a conventional RNTI) and are sixteen bits long. Moreover, each of NA-RNTI#1, NA-RNTI#2, NA-RNTI#3 is sixteen bits long.

Because the eNB 115 signals a set of possible user IDs (e.g. RNTIs) to the UEs UE 105₁-105₃, the eNB 115 does not have to dynamically send a user ID (e.g. RNTI) to cancel codeword interference.

For example, the eNB 115 may use a 2 bit indicator in the DCI to indicate each UE which NA-RNTI (or UE ID) to use per transmission time interval (TTI) instead of signaling the NA-RNTI each TTI.

In another example embodiment, each UE may blindly decode for the NA-RNTI using all of the NA-RNTIs in the set of NA-RNTIs.

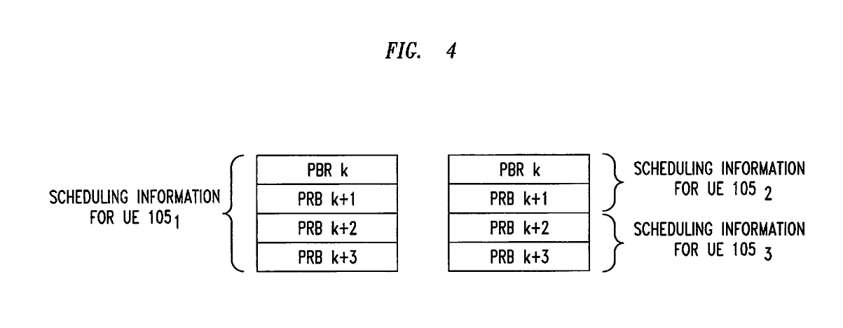

In FIG. 3, the eNB 115 decides to perform MU-MIMO pairing the UEs 105₁, 105₂ and 105₃, as shown in FIG. 4, in cell 110-1. That is the UE 105₁ is being interfered by the UEs 105₂ and 105₃ at different PRBs. The PRBs used for the UEs 105₂ and UE 105₃ overlap those used for the UE 105₁ in the PDSCH, as shown in FIG. 3.

More specifically, FIG. 4 illustrates an example embodiment of scheduled transmissions to the victim UE (e.g., UE 105₁) versus scheduled transmissions to the interfering UEs (e.g., UEs 105₂ and 105₃). As shown in FIG. 4, the UE 105₁ is scheduled on 4 PRBs: PRB k, PRB k+1, PRB k+2, PRB k+3. In PRB k and PRB k+1, the UE 105₁ is being interfered by the UE 105₂ because the UE 105₂ is also scheduled by the eNB 115 on PRB k and PRB k+1. In PRB k+2 and PRB k+3, the UE 105₁ is being interfered by the UE 105₃ because the UE 105₃ is also scheduled by the eNB 115 on PRB k+2 and PRB k+3.

Referring back to FIG. 3, the eNB 115 indicates to the UEs 105₂ and 105₃ in their DCI, respectively, to use NA-RNTI#2 when descrambling its signal, instead of using UE ID #2 and UE ID #3 as described existing PDSCH scrambling methods.

Alternatively, the UE 105₃ can use NA-RNTI#3. In this case, the eNB 115 tells the UE 105₁ that for PRBs k+2 and k+3 to use NA-RNTI#3 instead of NA-RNTI#2.

The control information containing the scheduling information for UE 105₂ and 105₃ is obtained by the victim UE 105₁. For example, the control information may be obtained as described in U.S. Patent Application Publication No. XX/XXX,XXX, entitled “Methods and Systems for Signaling Dynamic Network Assisted Information to a User Equipment,” filed on the same date as the present application and having the same inventive entity as the present application, the entire contents of which are hereby incorporated by reference.

The victim UE 105₁ uses its own identification UE ID#1 to decode its PDSCH signal and then uses NA-RNTI#2 to descramble and remove interference from the PDSCH.

If transport blocks sent to the UEs 105₂ and 105₃ are encoded with the same modulation and coding rate, then the victim UE 105₁ is able to decode them as if there came from one interferer. It should be noted that the victim UE 105₁ may not need to know that it has been interfered by two or more UEs.

In addition, the eNB 115 may indicate to the UE 105₁ to use NA-RNTI#1 in the DCI. As a result, UEs 105₂ and 105₃ can do a similar interference cancellation using NA-RNTI #1.

The total number of preconfigured RNTIs for MU-MIMO operation is determined by the number of MU pairings that the eNB 115 wishes to operate.

As described above, bits used to carry the RNTI of the interfering UE in a DCI message is significantly reduced since only an extra one or 2 bits are used in DCI based on the number of RNTIs in the set of RNTIs.

NA-RNTIs are always pre-configured by high layer signaling and all legacy PDSCH transmission is still fully supported.

When the cell 110-1 does not pair any UE for MU-MIMO or the cell 110-1 does not want the UE 105₁ to perform any interference cancellation (or does not want the UE 105₁ to use codeword interference cancellation), the cell 110-1 can scramble the UEs 105₂ and 105₃ using a legacy RNTI and does not pre-configure any of the NA-RNTIs to the UE 105₁ by high layer signaling or does not dynamically indicate any NA-RNTI to UE 105₁.

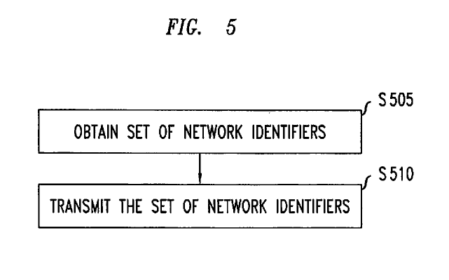

FIG. 5 illustrates a method of transmitting network identifiers in a network according to an example embodiment. It should be understood that the method of FIG. 5 may be implemented by the eNB 115 using the functionality described above.

At S505, the eNB 115 obtains a set of network identifiers for a victim user equipment (UE). The set includes at least a first identifier (e.g., UE ID #1) and at least a second identifier (e.g., NA-RNTI#2). The first identifier corresponds to a descrambling of a downlink signal for the victim UE and the second identifier corresponds to a descrambling of a first interfering signal. At S510, the eNB 115 transmits the set of network identifiers to the victim UE. Because the eNB 115 signals a set of possible user IDs (e.g., RNTIs) to the UEs UE 105₁-105₃, the eNB 115 does not have to dynamically send a user ID or RNTI to cancel codeword interference.

Example embodiments being thus described, it will be obvious that the same may be varied in many ways. Such variations are not to be regarded as a departure from the spirit and scope of example embodiments, and all such modifications as would be obvious to one skilled in the art are intended to be included within the scope of the claims.

What is claimed is:

1. A system comprising:
a network element configured to transmit a signal identifying a set of network identifiers to a victim user equipment (UE), the set including at least a first identifier and at least a second identifier, the first identifier corresponding to a descrambling of a downlink signal for the victim UE and the second identifier corresponding to a descrambling of a first interfering signal.

2. The system of claim 1, wherein the network element is configured to identify the second identifier in one of downlink control information (DCI) and a radio resource control (RRC) signal.

3. The system of claim 1, wherein the network element is configured to instruct the victim UE to use one of the network identifiers in downlink control information (DCI).

4. The system of claim 3, wherein the network element is configured to instruct the victim UE to use one of the network identifiers for each time transmission interval (TTI).

5. The system of claim 1, wherein the set of network identifiers is a set of scrambling identification candidates.

6. The system of claim 5, wherein the set of scrambling identification candidates is for decoding the interfering signal.

7. The system of claim 1, wherein a number of the network identifiers corresponds to a number of multiple user pairings.

8. The system of claim 1, wherein the interfering signal occurs at a same time and frequency as the downlink signal.

9. The system of claim 1, wherein the network element is configured to instruct an interfering UE to use the second identifier to descramble the interfering signal.

10. The system of claim 1, wherein the network element is configured to instruct the victim UE to use the first identifier to decode the downlink signal.

11. The system of claim 1, wherein the network element is configured to instruct the victim UE to use the second identifier to decode the downlink signal.

12. A user equipment (UE) comprising:
a processor configured to decode an interfering signal of a downlink signal on a shared downlink channel based on a set of known network identifiers.

13. The UE of claim 12, wherein the processor is configured to decode the interfering signal and the downlink signal based on a known set of network identifiers including a known network identifier associated with the UE and a known network identifier associated with at least one interfering UE.

14. A method of transmitting network identifiers in a network, the method comprising:
obtaining a set of network identifiers for a victim user equipment (UE), the set including at least a first identifier and at least a second identifier, the first identifier corresponding to a descrambling of a downlink signal for the victim UE and the second identifier corresponding to a descrambling of a first interfering signal; and
transmitting the set of network identifiers to the victim UE.

15. The method of claim 14, further comprising:
transmitting downlink control information (DCI) to the victim UE, the DCI indicating one of the network identifiers.

16. The method of claim 14, further comprising:
instructing the victim UE to use one of the network identifiers in downlink control information (DCI).

17. The method of claim 16, wherein the instructing instructs the victim UE to use one of the network identifiers for each time transmission interval (TTI).

18. The method of claim 14, wherein the set of network identifiers is a set of scrambling identification candidates.

19. The method of claim 18, wherein the set of scrambling identification candidates is for decoding the interfering signal.

20. The method of claim 14, wherein a number of the network identifiers corresponds to a number of multiple user pairings.

21. The method of claim 14, wherein the interfering signal occurs at a same time and frequency as the downlink signal.

22. The method of claim 14, further comprising:
instructing an interfering UE to use the second identifier to descramble the interfering signal.

23. The method of claim 14, further comprising:
instructing the victim UE to use the first identifier to decode the downlink signal.
